(19) United States
(12) Patent Application Publication
(10) Pub. No.: US 2023/0018720 A1
(43) Pub. Date: Jan. 19, 2023

(54) DEVICE AND METHOD FOR CONTROLLING AUTONOMOUS DRIVING

(71) Applicants: HYUNDAI MOTOR COMPANY, Seoul (KR); KIA CORPORATION, Seoul (KR)

(72) Inventor: Jung Wan Kim, Yongin-si (KR)

(73) Assignees: HYUNDAI MOTOR COMPANY, Seoul (KR); KIA CORPORATION, Seoul (KR)

(21) Appl. No.: 17/742,729

(22) Filed: May 12, 2022

(30) Foreign Application Priority Data
Jul. 12, 2021 (KR) 10-2021-0091223

(51) Int. Cl. B60W 30/14; B60W 60/00; B60W 40/10

(52) U.S. Cl. CPC B60W 30/146; B60W 60/001; B60W 40/1005; B60W 2530/16; B60W 2552/15; B60W 2510/182; B60W 2510/184; B60W 2520/10; B60W 2710/182; B60W 2720/10

(57) ABSTRACT

A device and a method for controlling autonomous driving control a speed of an autonomous vehicle before downhill travel. The device and method calculate a travel resistance of an autonomous vehicle on a travel-intended-route, including a downhill route, a main braking pressure required to travel at a constant speed, and a brake temperature based on braking. The device and method determine whether to reduce the main braking pressure based on the calculated brake temperature and calculates a decreased amount of the main braking pressure and an increased amount of a speed of the autonomous vehicle based on the decreased amount of the main braking pressure on the travel-intended-route when determining to reduce the main braking pressure. The device and method limit a maximum speed of the autonomous vehicle before entering the travel-intended-route based on the increased speed amount.

### CROSS-REFERENCE TO RELATED APPLICATION

This application claims the benefit of priority to Korean Patent Application No. 10-2021-0091223, filed in the Korean Intellectual Property Office on Jul. 12, 2021, the entire contents of which are incorporated herein by reference.

### TECHNICAL FIELD

The present disclosure relates to a device and a method for controlling autonomous driving, and more particularly, to a device and a method for controlling autonomous driving that control a speed of an autonomous vehicle before downhill travel.

### BACKGROUND

An autonomous vehicle is required to have an ability to adaptively cope with a surrounding situation that changes in real time during travel. For mass production and invigoration of the autonomous vehicle, a reliable determination control function is required above all. Autonomous vehicles that have been recently released basically perform driving, braking, and steering on behalf of a driver to reduce fatigue of the driver. Recently, the autonomous vehicles are being sold with a highway driving assist (HDA) function, a driver status warning (DSW) function, a driver awareness warning (DAW) function, and a forward collision-avoidance assist (FCA) or an active emergency brake system (AEBS) function. The DSW function may determine driver carelessness and state abnormalities, such as drowsy driving, distraction, and the like to output a warning alarm through a cluster and the like. The DAW function may determine whether the vehicle crosses a line and travels unstably through a front camera and the like. The FCA or AEBS function that performs sudden braking when detecting a forward collision, and the like.

In particular, fully autonomous driving is repeatedly operated in a more severe situation than a driving pattern of a general driver because the repeated operation is possible without considering the driver's fatigue. In particular, it is important for a vehicle transporting a large weight, such as a commercial vehicle, to secure a braking force of a level equal to or higher than a certain level for responding to an emergency situation to prevent accidents. When a commercial truck loaded with heavily weighted cargo continuously travels on a high downhill gradient in a situation in which a temperature of a brake disc is high, there is a risk of fire as well as a decrease in a braking force resulted from brake deterioration, Thus, there is a need to provide a technology to ameliorate such shortcomings.

### SUMMARY

The present disclosure has been made to solve the above-mentioned problems occurring in the prior art while advantages achieved by the prior art are maintained intact.

An aspect of the present disclosure provides a device and a method for controlling autonomous driving that control a speed of an autonomous vehicle before downhill travel.

Another aspect of the present disclosure provides a device and a method for controlling autonomous driving that prevent decrease in a braking force of a brake even in a harsh driving pattern of a fully autonomous vehicle without a driver by controlling a speed of the autonomous vehicle before downhill travel.

Another aspect of the present disclosure provides a device and a method for controlling autonomous driving that prevent deterioration of a brake in a downhill gradient travel situation of an autonomous vehicle.

Another aspect of the present disclosure provides a device and a method for controlling autonomous driving that prolong a life of a brake of an autonomous vehicle by limiting a speed of the autonomous vehicle to reduce fatigue of the brake.

Another aspect of the present disclosure provides a device and a method for controlling autonomous driving that control the autonomous driving such that the autonomous driving may be performed at a target speed by adjusting a speed of an autonomous vehicle after traveling a downhill gradient to a target speed.

The technical problems to be solved by the present inventive concept are not limited to the aforementioned problems. Any other technical problems not mentioned herein should be clearly understood from the following description by those having ordinary skill in the art to which the present disclosure pertains.

According to an aspect of the present disclosure, a device for controlling autonomous driving includes a calculation device configured to calculate a travel resistance of an autonomous vehicle on a travel-intended-route, including a downhill route, a main braking pressure required to travel at a constant speed, and a brake temperature based on braking. The device also includes a controller that determines whether to reduce the main braking pressure based on the calculated brake temperature. The controller also calculates a decreased amount of the main braking pressure and an increased amount of a speed of the autonomous vehicle based on the decreased amount of the main braking pressure on the travel-intended-route when determining to reduce the main braking pressure. The controller also limits a maximum speed of the autonomous vehicle before the autonomous vehicle enters the travel-intended-route based on the increased amount of the speed.

In one implementation, the calculation device may calculate the travel resistance based on an air resistance, a rolling resistance, and a gradient resistance.

In one implementation, the calculation device may calculate the main braking pressure based on a main braking force calculated based on the travel resistance and an auxiliary brake braking force.

In one implementation, the calculation device may calculate the main braking pressure based on the main braking force based on a mapping table for a correlation between a preset braking force and the main braking pressure.

In one implementation, the calculation device may store a braking force and the main braking pressure measured during braking of the autonomous vehicle while traveling as mapping data.

In one implementation, the calculation device may calculate the brake temperature based on the main braking pressure over time calculated through a gradient of the travel-intended-route.

In one implementation, the calculation device may calculate the brake temperature based on a temperature increase characteristic of a brake disc when the main braking pressure is applied and based on a temperature decrease characteristic of the brake disc when the main braking pressure is not applied.

In one implementation, the controller may determine to reduce the main braking pressure when the calculated brake temperature exceeds a preset reference temperature where a braking force of a brake is reduced by deterioration.

In one implementation, the controller may calculate the increased amount of the speed of the autonomous vehicle based on the decreased amount of the main braking pressure calculated such that the brake temperature does not exceed a preset reference temperature where a braking force of a brake is reduced by deterioration.

In one implementation, the controller may limit the maximum speed of the autonomous vehicle before the autonomous vehicle enters the travel-intended-route based on the speed increased amount such that a speed of the autonomous vehicle at an end point of the travel-intended-route is the same as a speed of the autonomous vehicle at the end point of the travel-intended-route when the main braking pressure is not reduced.

According to another aspect of the present disclosure, a method for controlling autonomous driving includes calculating, by a calculation device, a travel resistance of an autonomous vehicle on a travel-intended-route, including a downhill route, a main braking pressure required to travel at a constant speed, and a brake temperature based on braking. The method also includes determining, by a controller, whether to reduce the main braking pressure based on the calculated brake temperature. The method also includes calculating, by the controller, a decreased amount of the main braking pressure and an increased amount of a speed of the autonomous vehicle based on the decreased amount of the main braking pressure on the travel-intended-route when determining to reduce the main braking pressure, The method also includes limiting, by the controller, a maximum speed of the autonomous vehicle before the autonomous vehicle enters the travel-intended-route based on the increased amount of the speed.

In one implementation, the calculating, by the calculation device, of the travel resistance of the autonomous vehicle on the travel-intended-route, including the downhill route, the main braking pressure required to travel at the constant speed, and the brake temperature based on the braking may include calculating, by the calculation device, the travel resistance based on an air resistance, a rolling resistance, and a gradient resistance.

In one implementation, the calculating, by the calculation device, of the travel resistance of the autonomous vehicle on the travel-intended-route, including the downhill route, the main braking pressure required to travel at the constant speed, and the brake temperature based on the braking may include calculating, by the calculation device, the main braking pressure based on a main braking force calculated based on the travel resistance and an auxiliary brake braking force.

In one implementation, the calculating, by the calculation device, of the travel resistance of the autonomous vehicle on the travel-intended-route, including the downhill route, the main braking pressure required to travel at the constant speed, and the brake temperature based on the braking may include calculating, by the calculation device, the main braking pressure based on the main braking force based on a mapping table for a correlation between a preset braking force and the main braking pressure.

In one implementation, the method may further include storing, by the calculation device, a braking force and the main braking pressure measured during braking of the autonomous vehicle while traveling as mapping data.

In one implementation, the calculating, by the calculation device, of the travel resistance of the autonomous vehicle on the travel-intended-route, including the downhill route, the main braking pressure required to travel at the constant speed, and the brake temperature based on the braking may include calculating, by the calculation device, the brake temperature based on the main braking pressure over time calculated through a gradient of the travel-intended-route.

In one implementation, the calculating, by the calculation device, of the travel resistance of the autonomous vehicle on the travel-intended-route, including the downhill route, the main braking pressure required to travel at the constant speed, and the brake temperature based on the braking may include calculating, by the calculation device, the brake temperature based on a temperature increase characteristic of a brake disc when the main braking pressure is applied and based on a temperature decrease characteristic of the brake disc when the main braking pressure is not applied.

In one implementation, the determining, by the controller, of whether to reduce the main braking pressure based on the calculated brake temperature may include determining, by the controller, to reduce the main braking pressure when the calculated brake temperature exceeds a preset reference temperature where a braking force of a brake is reduced by deterioration.

In one implementation, the calculating, by the controller, of the decreased amount of the main braking pressure and the increased amount of the speed of the autonomous vehicle based on the decreased amount of the main braking pressure on the travel-intended-route when determining to reduce the main braking pressure may include calculating, by the controller, the increased amount of the speed of the autonomous vehicle based on the decreased amount of the main braking pressure calculated such that the brake temperature does not exceed a preset reference temperature where a braking force of a brake is reduced by deterioration.

In one implementation, the limiting, by the controller, of the maximum speed of the autonomous vehicle before the autonomous vehicle enters the travel-intended-route based on the increased amount of the speed may include limiting, by the controller, the maximum speed of the autonomous vehicle before the autonomous vehicle enters the travel-intended-route based on the speed increased amount such that a speed of the autonomous vehicle at an end point of the travel-intended-route is the same as a speed of the autonomous vehicle at the end point of the travel-intended-route when the main braking pressure is not reduced.

### BRIEF DESCRIPTION OF THE DRAWINGS

The above and other objects, features, and advantages of the present disclosure should be more apparent from the following detailed description taken in conjunction with the accompanying drawings:

FIG. 1 is a table in which automation levels of an autonomous vehicle are defined;

FIG. 2 is a block diagram illustrating an autonomous driving control device according to an embodiment of the present disclosure;

FIG. 3 is a diagram specifically illustrating a configuration of an autonomous driving control device according to an embodiment of the present disclosure;

FIG. 4 is a graph showing a braking force and an auxiliary brake stepping percentage;

FIG. 5 shows graphs respectively showing a relationship between a braking force and a brake pressure and showing the brake pressure based on a downhill gradient travel time;

FIG. 6 shows graphs illustrating a disc temperature over time when a brake is stepped or not stepped;

FIG. 7 is a graph for illustrating a process of determining whether a calculated brake temperature of an autonomous driving control device according to an embodiment of the present disclosure exceeds a brake deterioration point;

FIG. 8 shows graphs for illustrating a process in which an autonomous driving control device according to an embodiment of the present disclosure reduces a main braking pressure;

FIG. 9 shows graphs illustrating a speed changing as an autonomous driving control device according to an embodiment of the present disclosure reduces a main braking pressure;

FIGS. 10A and 10B are flowcharts illustrating an operation of an autonomous driving control device according to an embodiment of the present disclosure; and

FIG. 11 is a flowchart illustrating an autonomous driving control method according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function is omitted when it is determined that the related known configuration or function interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order, or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meanings in the context of the relevant art and should not be interpreted in an idealized or overly formal sense unless expressly so defined herein. When a component, device, element, or the like of the present disclosure is described as having a purpose or performing an operation, function, or the like, the component, device, or element should be considered herein as being “configured to” meet that purpose or to perform that operation or function.

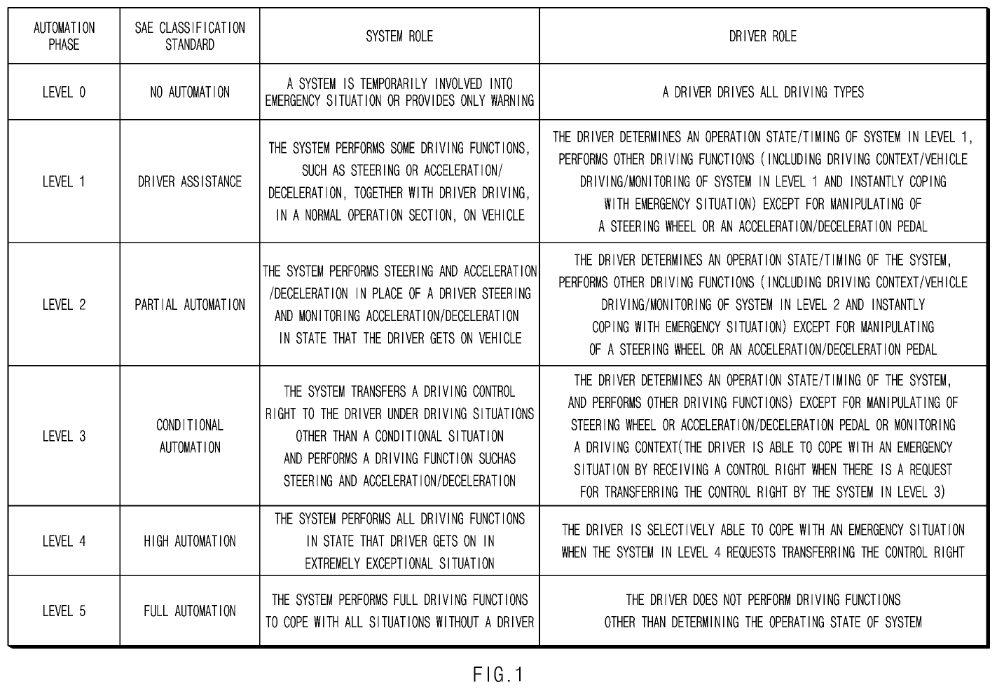

Hereinafter, embodiments of the present disclosure are described in detail with reference to FIGS. 1-11.

FIG. 1 is a table in which automation levels of an autonomous vehicle are defined.

The autonomous vehicle refers to a vehicle that recognizes a travel environment by itself to determine a risk, minimizes travel manipulation of a driver while controlling a travel route, and drives by itself.

Ultimately, the autonomous vehicle refers to a vehicle capable of traveling, controlling, and parking without an influence of humans. The autonomous vehicle is in a state in which an autonomous driving technology is the most advanced.

The autonomous driving technology is a core foundation of the autonomous vehicle, i.e., an ability to operate the vehicle without active control or monitoring of the driver.

However, a current concept of the autonomous vehicle may include an intermediate stage of automation to the autonomous vehicle in a full sense as shown in FIG. 1. The current concept of the autonomous vehicle may correspond to a goal-oriented concept on the premise of mass production and commercialization of a fully autonomous vehicle.

A device and a method for controlling autonomous driving according to the present disclosure may be applied to an autonomous vehicle corresponding to a level 5 (fully autonomous driving) among automation steps of the autonomous driving shown in FIG. 1. However, the present disclosure may not be necessarily limited thereto. The device and the method for controlling the autonomous driving may be applied to autonomous vehicles of all levels that require transfer of a control right and vehicle control for a system failure during the autonomous driving.

The automation levels of the autonomous vehicle according to the Society of Automotive Engineers (SAE), which is an American association of automotive engineers, may be classified as shown in the table in FIG. 1.

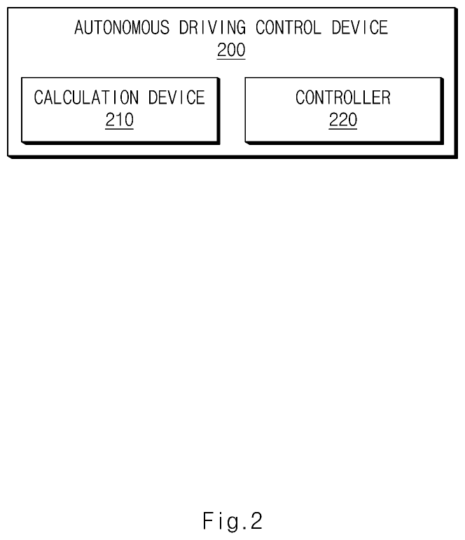

FIG. 2 is a block diagram illustrating an autonomous driving control device according to an embodiment of the present disclosure.

Referring to FIG. 2, an autonomous driving control device 200 may include a calculation device 210 and a controller 220.

The autonomous driving control device 200 according to the present disclosure may be implemented inside or outside the vehicle. In this connection, the autonomous driving control device 200 may be integrally formed with internal control units of the vehicle or may be implemented as a separate hardware device and connected to the control units of the vehicle by connection means.

As an example, the autonomous driving control device 200 may be implemented integrally with the vehicle. The autonomous driving control device 200 may also be implemented in a form of being installed in/attached to the vehicle as a component separate from the vehicle. The autonomous driving control device 200 may also be implemented in a form in which a portion thereof is implemented integrally with the vehicle and the remaining portion thereof is installed in/attached to the vehicle as a component separate from the vehicle.

The calculation device 210 may calculate a travel resistance of the autonomous vehicle on a travel-intended-route, including a downhill route, a main braking pressure required to travel at a constant speed, and a brake temperature based on braking.

As an example, the calculation device 210 may be connected to an autonomous driving system of the vehicle and may obtain information on whether the downhill route is included in the travel-intended-route of the autonomous vehicle.

As an example, the calculation device 210 may calculate the travel resistance based on an air resistance, a rolling resistance, and a gradient resistance.

As an example, the calculation device 210 may calculate the air resistance on the downhill route as in [Equation 1] based on an air resistance coefficient, a cross-sectional area of the vehicle exposed to an air flow, an air density, and a speed of the vehicle.

$$AR = {C}_{w} \cdot A \cdot \frac{ρ}{2} \cdot {V}_{veh}^{2} \qquad [ Equation 1 ]$$

Here, AR may be the air resistance ([N]), C_{w} may be the air resistance coefficient, “A” may be the cross-sectional area of the vehicle exposed to the air flow, ρ may be the air density, and Vᵥₑₕ may be a variable indicating the speed of the vehicle.

As an example, the calculation device 210 may calculate the rolling resistance on the downhill route as in [Equation 2] based on a rolling friction coefficient, a mass of the vehicle, a gravitational acceleration, and an inclination angle of the downhill route.

RR=f·mᵥₑₕ·g·cos(α_{gr}) [Equation 2]

Here, RR may be the rolling resistance ([N]), “f” may be the rolling friction coefficient, mᵥₑₕ may be the mass of the vehicle, “g” may be the gravitational acceleration, and α_{gr} may be a variable indicating the inclination angle of the downhill route.

As an example, the calculation device 210 may calculate the gradient resistance on the downhill route as in [Equation 3] based on the mass of the vehicle, the gravitational acceleration, and the inclination angle of the downhill route.

GR=mᵥₑₕ·gsin(α_{fr}) [Equation 3]

Here, GR may be the gradient resistance ([N]), mᵥₑₕ may be the mass of the vehicle, “g” may be the gravitational acceleration, and α_{gr} may be the variable indicating the inclination angle of the downhill route.

As an example, the calculation device 210 may use the pre-stored values of the air resistance coefficient, the cross-sectional area of the vehicle exposed to the air flow, the air density, the mass of the vehicle, and the gravitational acceleration to calculate the air resistance, the rolling resistance, and the gradient resistance. The calculation device 210 may use information, which is obtained from the autonomous driving system, on the speed of the vehicle, the rolling friction coefficient, and the inclination angle of the downhill route that vary based on the downhill route.

Specifically, the calculation device 210 may calculate the travel resistance by subtracting the gradient resistance from a sum of the air resistance and the rolling resistance on the downhill route.

As an example, the calculation device 210 may calculate the main braking pressure based on a main braking force calculated based on the travel resistance and an auxiliary brake braking force.

Specifically, the calculation device 210 may calculate the main braking force required to travel at the constant speed on the downhill route by summing the travel resistance and the auxiliary brake braking force.

As an example, the calculation device 210 may calculate the main braking pressure based on the main braking force based on a mapping table for a correlation between a preset braking force and the main braking pressure.

As an example, the calculation device 210 may calculate the main braking pressure based on the main braking force using information on the mapping table for the correlation between the preset braking force stored in a memory and the main braking pressure.

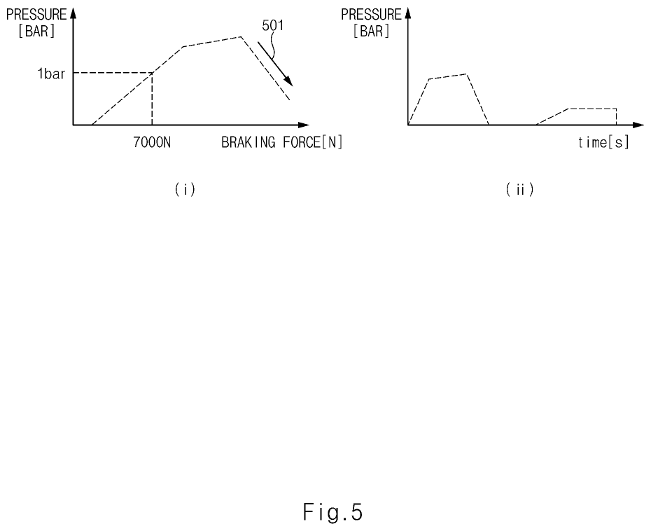

The mapping table for the correlation between the braking force and the main braking pressure is described below in detail with reference to FIG. 5.

As an example, the calculation device 210 may store the braking force and the main braking pressure measured during the braking of the autonomous vehicle while traveling as mapping data.

As an example, the calculation device 210 may obtain the braking force and the main braking pressure from sensors during the braking of the autonomous vehicle while the autonomous vehicle is traveling. The calculation device 210 may also accumulate and store mapping information of the braking force and the main braking pressure in the memory to create the mapping table.

As an example, the calculation device 210 may calculate the brake temperature based on the main braking pressure over time calculated through a gradient of the travel-intended-route.

As an example, the calculation device 210 may calculate the main braking pressure corresponding to the required main braking force over time through the gradient of the travel-intended-route for each position obtained through the autonomous driving system.

As an example, the calculation device 210 may calculate the brake temperature based on a temperature increase characteristic of a brake disc when the main braking pressure is applied and based on a temperature decrease characteristic of the brake disc when the main braking pressure is not applied.

As an example, the brake temperature over time may be calculated using the temperature increase characteristic of the brake disc when the main braking pressure is applied and using the temperature decrease characteristic of the brake disc when the main braking pressure is not applied corresponding to the calculated main braking pressure.

The controller 220 may determine whether to reduce the main braking pressure based on the calculated brake temperature.

As an example, when the calculated brake temperature exceeds a preset reference temperature at which the braking force of the brake is reduced by deterioration, the controller 220 may determine to reduce the main braking pressure.

As an example, when there is a section in which the calculated brake temperature exceeds the preset reference temperature, the controller 220 may determine to reduce the main braking pressure.

As an example, when determining to reduce the main braking pressure, the controller 220 may calculate a decreased amount of the main braking pressure and an increased amount of the speed of the autonomous vehicle based on the decreased amount of the main braking pressure on the travel-intended-route.

As an example, the controller 220 may calculate the increased amount of the speed of the autonomous vehicle based on the decreased amount of the main braking pressure calculated such that the brake temperature does not exceed the preset reference temperature at which the braking force of the brake is reduced by the deterioration.

As an example, the controller 220 may obtain an acceleration of the autonomous vehicle on the downhill route based on the travel resistance, the auxiliary brake braking force, and the main braking force, which is reduced as the main braking pressure decreases, calculated in the calculation device 210. The controller 220 may also calculate the increased amount of the speed of the autonomous vehicle in the process of traveling on the downhill route based on the autonomous driving acceleration.

As an example, the controller 220 may limit a maximum speed of the autonomous vehicle before the autonomous vehicle enters the travel-intended-route, based on the increased amount of the speed.

As an example, the controller 220 may be connected to the autonomous driving system and may limit the maximum speed of the autonomous vehicle before the autonomous vehicle enters the travel-intended-route through a driving controller included in the autonomous driving system.

As an example, the controller 220 may limit the maximum speed of the autonomous vehicle based on the increased amount of the speed before the autonomous vehicle enters the travel-intended-route such that a speed of the autonomous vehicle at an end point of the travel-intended-route is the same as a speed of the autonomous vehicle at the end point of the travel-intended-route in a case in which the main braking pressure is not reduced.

As an example, the controller 220 may limit the maximum speed of the autonomous vehicle so as not to exceed a speed obtained by subtracting the increased amount of the speed of the autonomous vehicle due to the reduction of the main braking pressure from an existing or present target speed before the autonomous vehicle enters the travel-intended-route of the autonomous vehicle.

As an example, the controller 220 may change the target speed to the speed obtained by subtracting the increased amount of the speed of the autonomous vehicle due to the reduction of the main braking pressure from the existing target speed before the autonomous vehicle enters the travel-intended-route of the autonomous vehicle.

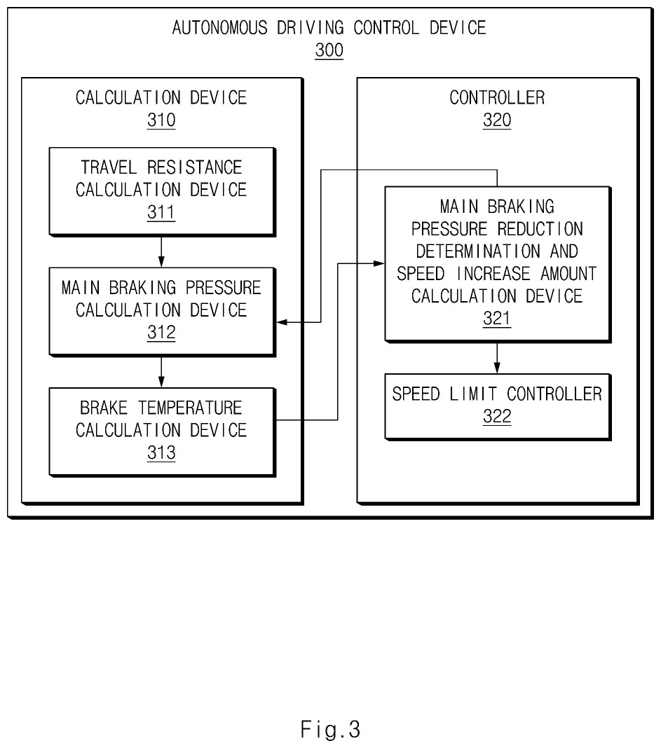

FIG. 3 is a diagram specifically illustrating a configuration of an autonomous driving control device according to an embodiment of the present disclosure.

Referring to FIG. 3, an autonomous driving control device 300 may include a calculation device 310 and a controller 320.

The calculation device 310 may include a travel resistance calculation device 311, a main braking pressure calculation device 312, and a brake temperature calculation device 313.

The travel resistance calculation device 311 may calculate the travel resistance based on the air resistance, the rolling resistance, and the gradient resistance.

As an example, the travel resistance calculation device 311 may calculate the travel resistance by subtracting the gradient resistance from the sum of the air resistance and the rolling resistance.

The travel resistance calculation device 311 may transmit information on the calculated travel resistance to the main braking pressure calculation device 312.

The main braking pressure calculation device 312 may calculate the main braking pressure corresponding to the main braking force calculated based on the travel resistance and the auxiliary brake braking force.

As an example, when the sum of the travel resistance and the auxiliary brake braking force is negative, the main braking pressure calculation device 312 may calculate an absolute value thereof as the main braking force and may calculate the main braking pressure by applying the mapping table of the correlation between the preset braking force and the main braking pressure to the main braking force.

The main braking pressure calculation device 312 may transmit information on the calculated main braking pressure to the brake temperature calculation device 313.

The brake temperature calculation device 313 may calculate the brake temperature based on the main braking pressure over time calculated through the gradient of the travel-intended-route.

As an example, the brake temperature calculation device 313 may calculate the brake temperature over time by applying the main braking pressure over time calculated through the gradient of the travel-intended-route to the temperature increase characteristic of the brake disc when the main braking pressure is applied and the temperature reduction characteristic of the brake disc when the main braking pressure is not applied.

The brake temperature calculation device 313 may transmit information on the calculated brake temperature over time to a main braking pressure reduction determination and speed increased amount calculation device 321.

The controller 320 may include the main braking pressure reduction determination and speed increased amount calculation device 321 and a speed limit controller 322.

The main braking pressure reduction determination and speed increased amount calculation device 321 may determine to reduce the main braking pressure when the calculated brake temperature exceeds the deterioration temperature at which the braking force of the brake is reduced by the deterioration. The main braking pressure reduction determination and speed increased amount calculation device 321 may also calculate the increased amount of the speed of the autonomous vehicle based on the calculated decreased amount of the main braking pressure.

As an example, when there is the section in which the calculated brake temperature over time exceeds the deterioration temperature at which the braking force of the brake is reduced by the deterioration, the main braking pressure reduction determination and speed increased amount calculation device 321 may determine to reduce the braking pressure.

As an example, when determining to reduce the braking pressure, the main braking pressure reduction determination and speed increased amount calculation device 321 may calculate the acceleration on the downhill route based on the decreased amount of the main braking pressure and calculate the increased amount of the speed of the autonomous vehicle when the autonomous vehicle travels on the downhill route based on the calculated acceleration.

The main braking pressure reduction determination and speed increased amount calculation device 321 may transmit information on the increased amount of the speed of the autonomous vehicle to the main braking pressure calculation device 312 and the speed limit controller 322.

The main braking pressure calculation device 312 may receive feedback on the information on the increased amount of the speed of the autonomous vehicle and may re-calculate the main braking pressure.

The speed limit controller 322 may limit the maximum speed of the autonomous vehicle based on the increased amount of the speed before the autonomous vehicle enters the travel-intended-route such that the speed of the autonomous vehicle at the end point of the travel-intended-route is the same as the speed of the autonomous vehicle at the end point of the travel-intended-route in the case in which the main braking pressure is not reduced.

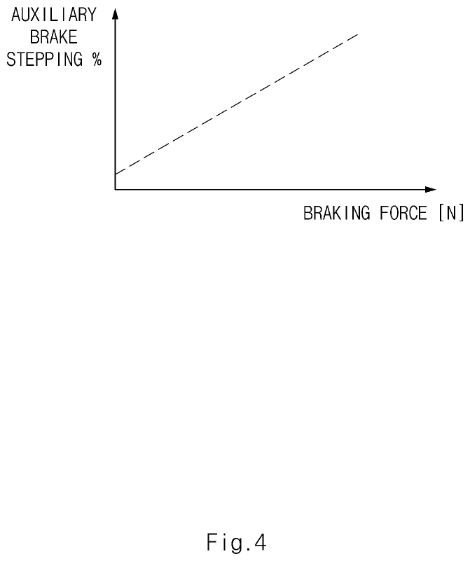

FIG. 4 is a graph showing a braking force and an auxiliary brake stepping percentage.

Referring to FIG. 4, the autonomous driving control devices 200 and 300 may identify a relationship between the braking force and the corresponding auxiliary brake stepping percentage through the graph.

The autonomous driving control devices 200 and 300 may determine the auxiliary brake braking force based on the auxiliary brake stepping percentage and may calculate the sum of the calculated travel resistance and the auxiliary brake braking force.

When the sum of the travel resistance and the auxiliary brake braking force is negative, the autonomous driving control devices 200 and 300 may allow the autonomous vehicle to travel at the constant speed by additionally applying the main braking force in the process of traveling on the downhill route.

Therefore, when the sum of the travel resistance and the auxiliary brake braking force is negative, the autonomous driving control devices 200 and 300 may calculate the absolute value thereof as the main braking force.

FIG. 5 shows graphs respectively showing a relationship between a braking force and a brake pressure and showing the brake pressure based on a downhill gradient travel time.

Graph (i) of FIG. 5 is a graph showing a pressure of a main brake based on the braking force.

As an example, there may be a case in which the pressure of the main brake should be 1 bar to output a braking force of 7,000 N.

A section 501 in which the pressure of the main brake is decreased as the braking force is increased may be a section representing braking force deterioration resulted from wheel lock of the autonomous vehicle.

The autonomous driving control devices 200 and 300 may calculate a total resistance (TR) and a total brake resistance (TB, Total Brake Resistance without main brake) as in [Equation 4] and [Equation 5].

TR=RR+AR−GR [Equation 4]

TB=TR+auxiliary braking force(regenerative braking, auxiliary brake) [Equation 5]

The autonomous driving control devices 200 and 300 may calculate a negative value of the total brake resistance calculated based on [Equation 4] and [Equation 5] as a braking force of the main brake.

When the total brake resistance is negative, there may be a case in which the speed on the downhill is not able to be maintained without stepping of the main brake, such as a case of a travel route with a large downhill inclination or a case in which the vehicle is heavy, so that the autonomous driving control devices 200 and 300 may create a compensation profile through an increase in the braking pressure

The autonomous driving control devices 200 and 300 may obtain the main braking pressure by applying the mapping table of the correlation between the braking force and the main braking pressure to the calculated braking force of the main brake.

Graph (ii) of FIG. 5 is a graph showing the brake pressure based on the downhill gradient travel time.

The autonomous driving control devices 200 and 300 may calculate the main braking force over time by reflecting information on the downhill route and the target speed identified through the autonomous driving system. The autonomous driving control devices 200 and 300 may also calculate the main braking pressure over time based on the calculated main braking force.

As an example, the autonomous driving control devices 200 and 300 may reflect information on the calculated main braking pressure over time to re-calculate the fed back travel resistance.

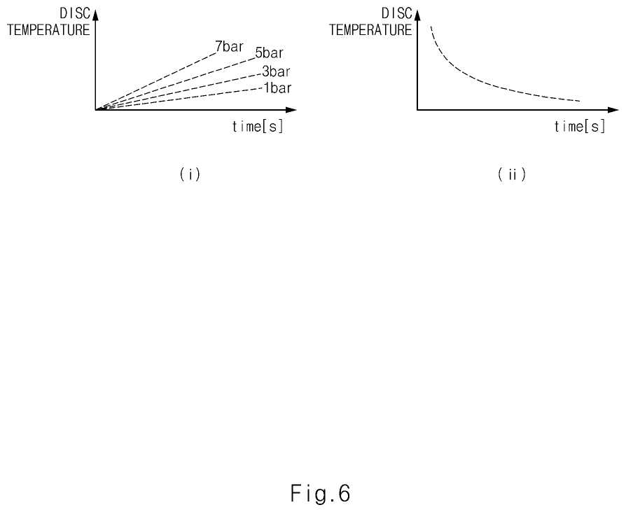

FIG. 6 includes graphs showing a disc temperature over time when a brake is stepped or not stepped.

Graph (i) of FIG. 6 is a graph showing a change in the temperature of the brake disc over time when the brake is stepped for each main braking pressure of the brake.

When the brake is stepped, heat may be generated by friction of the brake disc, so that the temperature of the brake disc may increase.

In this connection, the greater the main braking pressure, the stronger the friction and the more heat is generated, so that the temperature of the brake disc may rise steeply over time.

There may be an error, but when the main braking pressure is constant, the disc temperature may rise linearly over time.

Graph (ii) of FIG. 6 is a graph showing a change in the temperature of the brake disc over time when the brake is not stepped.

When the brake is not stepped, the heat resulted from the brake friction does not occur, so that the disc temperature may decrease by a temperature of air.

When the main braking pressure is constant, a width at which the disc temperature decreases may decrease over time, and the disc temperature may decrease by converging to a specific temperature.

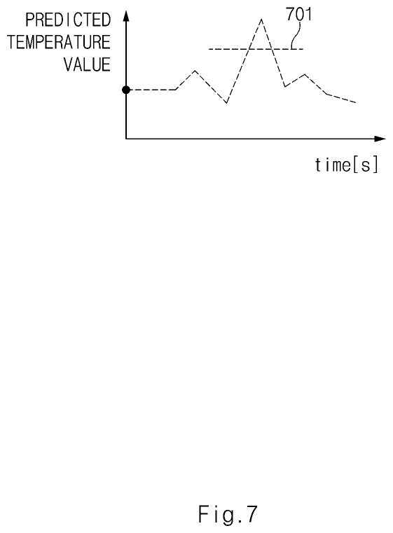

FIG. 7 is a graph for illustrating a process of determining whether a calculated brake temperature of an autonomous driving control device according to an embodiment of the present disclosure exceeds a brake deterioration point.

Referring to FIG. 7, the autonomous driving control devices 200 and 300 may calculate the temperature of the brake over time based on whether the main braking pressure is applied over time, the main braking pressure, and the temperature reduction characteristic of the brake disc depending on whether the brake is stepped/not stepped.

The autonomous driving control devices 200 and 300 may determine whether there is a portion in which the temperature of the brake over time exceeds a deterioration point 701 of the brake disc.

When there is the portion in which the temperature of the brake over time exceeds the deterioration point 701 of the brake disc, the autonomous driving control devices 200 and 300 may adjust the travel speed in advance before the autonomous vehicle enters the downhill route corresponding to the corresponding portion to reduce the main braking pressure of the brake. Such a configuration allows the temperature of the brake not to exceed the brake deterioration point 701.

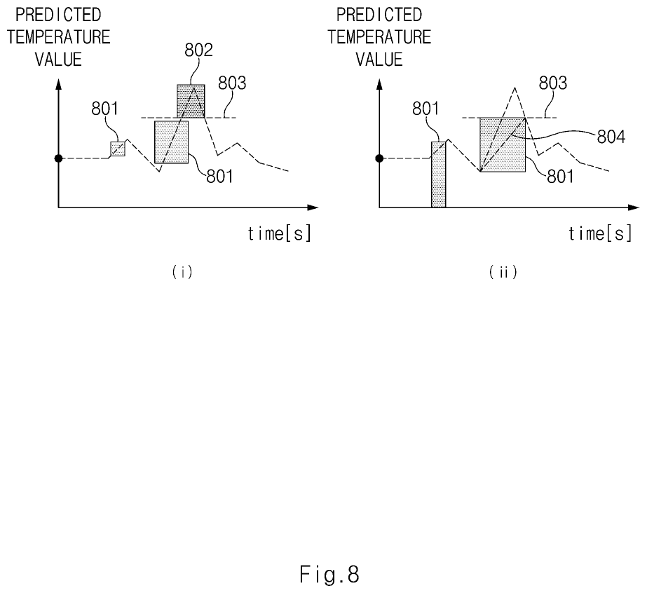

FIG. 8 includes graphs for illustrating a process in which an autonomous driving control device according to an embodiment of the present disclosure reduces a main braking pressure.

Graph (i) of FIG. 8 is a graph showing predicted temperature values over time in the case in which the main braking pressure of the brake is not reduced.

A section 801 is a section to which the main braking pressure of the brake is applied, and the temperature of the brake rises over time in the corresponding section.

A section of 802 is a section in which the predicted temperature value of the brake exceeds a deterioration reference temperature 803.

When there is the section of 802, the braking force reduction by the brake deterioration may occur, so that the autonomous driving control devices 200 and 300 may reduce the main braking pressure to prevent the brake deterioration.

Graph (ii) of FIG. 8 is a graph showing predicted temperature values over time when the main braking pressure of the brake is reduced.

When the autonomous driving control devices 200 and 300 reduce the main braking pressure, an inclination of the increase in the brake temperature over time is changed to be gentle when the brake pressure is applied.

In this case, the graph of the predicted temperature value over time may change as in a section of 804. Accordingly, because the predicted temperature value exceeds the deterioration reference temperature 803, the section 802 in which the brake braking force decreases may be eliminated.

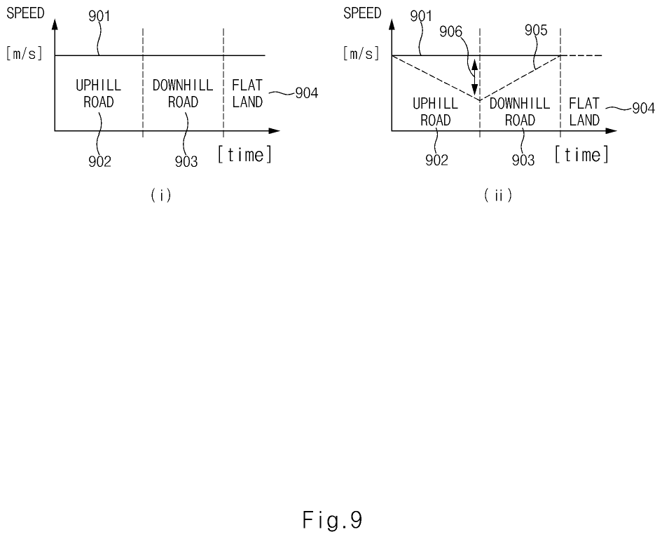

FIG. 9 includes graphs illustrating a speed changing as an autonomous driving control device according to an embodiment of the present disclosure reduces a main braking pressure.

Graph (i) of FIG. 9 is a graph showing the speed of the autonomous vehicle over time when the autonomous vehicle travels at the existing target travel speed as the autonomous driving control devices 200 and 300 do not reduce the main braking pressure.

When the autonomous driving control devices 200 and 300 do not reduce the main braking pressure, the autonomous vehicle may travel constantly on an uphill road 902, a downhill road 903, and a flat land 904 at an existing target travel speed 901.

Graph (ii) of FIG. 9 is a graph showing the speed of the autonomous vehicle over time when the autonomous vehicle travels at the existing travel target speed as the autonomous driving control devices 200 and 300 reduce the main braking pressure.

The autonomous driving control devices 200 and 300 may limit a speed before the autonomous vehicle enters the downhill route 903 when reducing the main braking pressure.

In this case, the autonomous driving control devices 200 and 300 may control the speed of the autonomous vehicle to become a speed reduced by a specific speed 906 from the existing target speed 901 when the autonomous vehicle enters the downhill road 903. The speed reduction may be performed by reducing the speed of the autonomous vehicle in the section of the uphill road 902 from a specific distance before the autonomous vehicle enters the downhill road 903.

As an example, the autonomous driving control devices 200 and 300 may set the specific speed 906 reduced from the existing speed as an increased amount of the speed of the autonomous vehicle by the reduction of the main braking pressure.

As the autonomous driving control devices 200 and 300 reduce the main braking pressure on the downhill road 903, the speed of the autonomous vehicle may increase 905 at a certain inclination because the braking force is insufficient.

The autonomous driving control devices 200 and 300 may control the speed of the autonomous vehicle such that a speed at a time point of entering the flat land 904 after the travel of the downhill road 903 is reduced in advance by the increased amount of the speed of the autonomous vehicle due to the reduction of the main braking pressure.

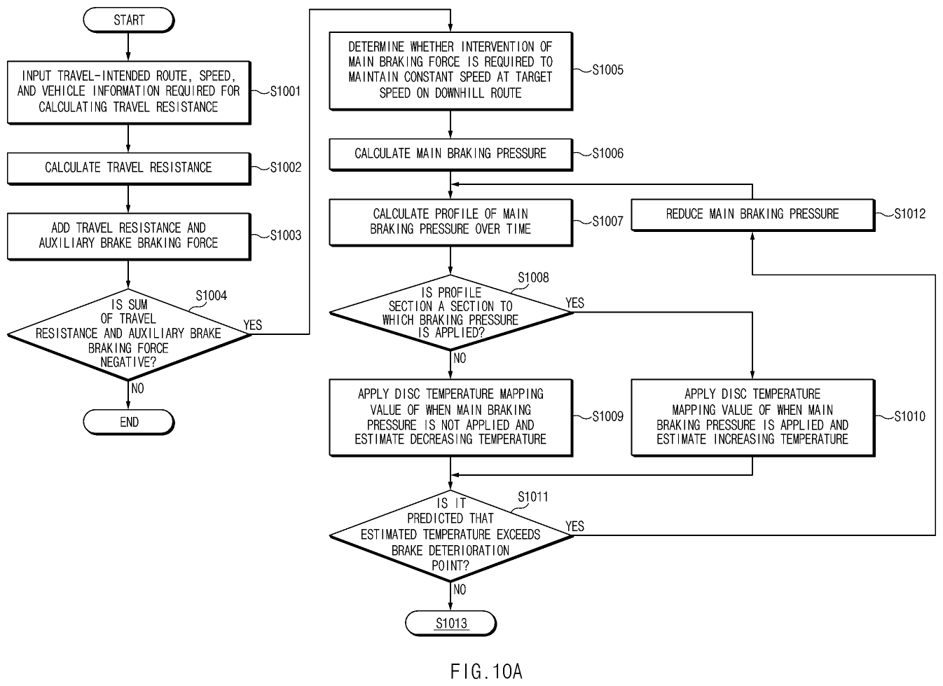

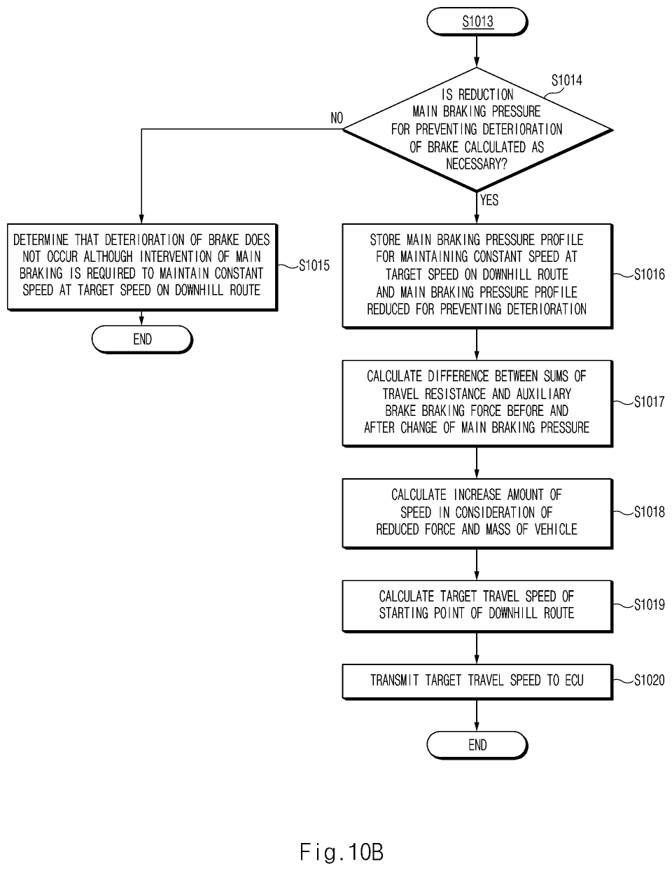

FIGS. 10A and 10B are flowcharts illustrating an operation of an autonomous driving control device according to an embodiment of the present disclosure.

Referring to FIG. 10A, the autonomous driving control devices 200 and 300 may receive the travel-intended route, the speed, and vehicle information required for calculating the travel resistance (S1001).

As an example, the autonomous driving control devices 200 and 300 may receive the travel-intended-route and the speed through the autonomous driving system. The autonomous driving control devices 200 and 300 may also receive the vehicle pre-stored information required for calculating the travel resistance, such as the air resistance, the friction coefficient, the cross-sectional area of the vehicle for the air flow, and the like.

The autonomous driving control devices 200 and 300 may receive the travel-intended route, the speed, and the vehicle information required for calculating the travel resistance (S1001) and then may calculate the travel resistance (S1002).

As an example, the autonomous driving control devices 200 and 300 may calculate the travel resistance by subtracting the gradient resistance from the sum of the air resistance and the rolling resistance.

The autonomous driving control devices 200 and 300 may calculate the travel resistance (S1002) and then may add the travel resistance and the auxiliary brake braking force (S1003).

The autonomous driving control devices 200 and 300 may add the travel resistance and the auxiliary brake braking force (S1003) and then may determine whether the sum of the travel resistance and the auxiliary brake braking force is negative (S1004).

The autonomous driving control devices 200 and 300 may determine whether the sum of the travel resistance and the auxiliary brake braking force is negative (S1004). Then, when it is determined that the sum of the travel resistance and the auxiliary brake braking force is negative (YES in S1004), the autonomous driving control devices 200 and 300 may determine whether intervention of the main braking force is required to maintain the constant speed at the target speed on the downhill route (S1005).

As an example, when it is determined that the sum of the travel resistance and the auxiliary brake braking force is negative, the autonomous driving control devices 200 and 300 may determine that the intervention of the main braking force is required to maintain the constant speed at the target speed on the downhill route.

The autonomous driving control devices 200 and 300 may determine whether the intervention of the main braking force is required to maintain the constant speed at the target speed on the downhill route (S1005) and may then calculate the main braking pressure (S1006).

As an example, when the sum of the travel resistance and the auxiliary brake braking force is negative, the autonomous driving control devices 200 and 300 may calculate the absolute value thereof as the main braking pressure.

The autonomous driving control devices 200 and 300 may calculate the main braking pressure (S1006) and then may calculate a profile of the main braking pressure over time (S1007).

As an example, the autonomous driving control devices 200 and 300 may calculate a required main braking force profile over time based on the gradient of the travel-intended-route for each position obtained through the autonomous driving system (S1007). The autonomous driving control devices 200 and 300 may calculate the profile of the main braking pressure over time based on the mapping table of the correlation between the pre-set braking force and the main braking pressure (S1007).

The autonomous driving control devices 200 and 300 may calculate the profile of the main braking pressure over time (S1007) and then may determine whether a section based on a downhill route travel time is a section to which the braking pressure is applied (S1008).

As an example, the autonomous driving control devices 200 and 300 may identify a section where the main braking pressure is positive based on the profile of the main braking pressure over time to determine whether the section based on the downhill route travel time is the section to which the braking pressure is applied (S1008).

The autonomous driving control devices 200 and 300 may determine whether the section based on the downhill route travel time is the section to which the braking pressure is applied (S1008). Then, when it is determined that the section based on the downhill route travel time is not the section to which the braking pressure is applied (NO in S1008), the autonomous driving control devices 200 and 300 may calculate a decreased disc temperature by applying a disc temperature mapping value when the main braking pressure is not applied (S1009).

The autonomous driving control devices 200 and 300 may determine whether the section based on the downhill route travel time is the section to which the braking pressure is applied (S1008). Then, when it is determined that the section based on the downhill route travel time is the section to which the braking pressure is applied (YES in S1008), the autonomous driving control devices 200 and 300 may calculate an increased disc temperature by applying the disc temperature mapping value when the main braking pressure is applied (S1010).

The autonomous driving control devices 200 and 300 may calculate the decreasing disc temperature by applying the disc temperature mapping value when the main braking pressure is not applied (S1009) and then may determine whether it is predicted that the calculated temperature exceeds the brake deterioration point (S1011).

The autonomous driving control devices 200 and 300 may calculate the increasing disc temperature by applying the disc temperature mapping value when the main braking pressure is applied (S1010) and may then determine whether it is predicted that the calculated temperature exceeds the brake deterioration point (S1011).

As an example, the autonomous driving control devices 200 and 300 may determine whether there is the section in which the calculated brake temperature exceeds the preset reference temperature.

The autonomous driving control devices 200 and 300 may determine whether it is predicted that the calculated temperature exceeds the brake deterioration point (S1011). Then, when it is determined that it is predicted that the calculated temperature exceeds the brake deterioration point (YES in S1011), the autonomous driving control devices 200 and 300 may reduce the main braking pressure (S1012).

As an example, the autonomous driving control devices 200 and 300 may reduce the main braking pressure such that the temperature of the brakes does not exceed the brake deterioration point.

The autonomous driving control devices 200 and 300 may reduce the main braking pressure (S1012) and then may calculate the profile of the main braking pressure over time by going back to the S1007.

The autonomous driving control devices 200 and 300 may determine whether it is predicted that the calculated temperature exceeds the brake deterioration point (S1011). Then, when it is determined that it is not predicted that the calculated temperature exceeds the brake deterioration point (NO in S1011), the operation of the autonomous driving control device may enter S1013.

A description is made with reference to FIG. 10B from S1013.

Referring to FIG. 10B, after entering S1013, the autonomous driving control devices 200 and 300 may determine whether the reduction of the main braking pressure for preventing the deterioration of the brake is calculated as necessary (S1014).

As an example, the autonomous driving control devices 200 and 300 may determine that the reduction of the main braking pressure is calculated as necessary when there is the section in which the calculated brake temperature exceeds the preset reference temperature.

The autonomous driving control devices 200 and 300 may determine whether the reduction of the main braking pressure for preventing the deterioration of the brake is calculated as necessary (S1014). Then, when it is determined that the reduction of the main braking pressure for preventing the deterioration of the brake is not calculated as necessary (NO in S1014), the autonomous driving control devices 200 and 300 may determine that the deterioration of the brake does not occur although the intervention of the main braking is required to maintain the constant speed at the target speed on the downhill route (S1015).

As an example, the autonomous driving control devices 200 and 300 may control the travel of the autonomous vehicles by applying the main braking pressure as calculated when it is determined that the deterioration of the brake does not occur although the intervention of the main braking is required to maintain the constant speed at the target speed on the downhill route.

The autonomous driving control devices 200 and 300 may determine whether the reduction of the main braking pressure for preventing the deterioration of the brake is calculated as necessary (S1014). Then, when it is determined that the reduction of the main braking pressure for preventing the deterioration of the brake is calculated as necessary (YES in S1014), the autonomous driving control devices 200 and 300 may store a main braking pressure profile for maintaining the constant speed at the target speed on the downhill route and a main braking pressure profile reduced for preventing the deterioration (S1016).

The autonomous driving control devices 200 and 300 may store the main braking pressure for maintaining the constant speed at the target speed on the downhill route and the main braking pressure profile reduced for preventing the deterioration (S1016). Then, the autonomous driving control devices 200 and 300 may calculate a difference between the sums of the travel resistance and the auxiliary brake braking force before and after the change of the main braking pressure

(S1017).

The autonomous driving control devices 200 and 300 may calculate the difference between the sums of the travel resistance and the auxiliary brake braking force before and after the change of the main braking pressure (S1017) and then may calculate the increased amount of the speed in consideration of the reduced force and the mass of the vehicle (S1018).

As an example, the autonomous driving control devices 200 and 300 may calculate the changed acceleration based on the reduced force and the mass of the vehicle, and then calculate the increased amount of the speed based on the calculated acceleration.

The autonomous driving control devices 200 and 300 may calculate the increased amount of the speed in consideration of the reduced force and the mass of the vehicle (S1018) and then may calculate a new target travel speed of a starting point of the downhill route (S1019).

As an example, the autonomous driving control devices 200 and 300 may calculate a new target travel speed of the autonomous vehicle before the autonomous vehicle enters the travel-intended-route such that the speed of the autonomous vehicle at the end point of the travel-intended-route is the same as the speed of the autonomous vehicle at the end point of the travel-intended-route in the case in which the main braking pressure is not reduced.

The autonomous driving control devices 200 and 300 may calculate the new target travel speed of the starting point of the downhill route (S1019) and then may transmit the target travel speed to an electronic control unit (ECU) (S1020).

Thereafter, the autonomous vehicle travels with the target travel speed of the autonomous vehicle limited by the ECU, and thus the deterioration of the brake may be prevented.

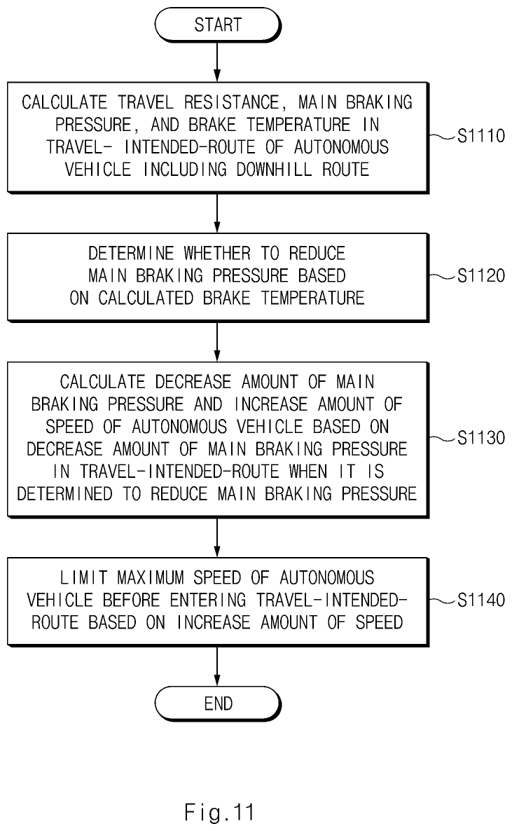

FIG. 11 is a flowchart illustrating an autonomous driving control method according to an embodiment of the present disclosure.

Referring to FIG. 11, the autonomous driving control method may include calculating the travel resistance, the main braking pressure, and the brake temperature in the travel-intended-route of the autonomous vehicle including the downhill route (S1110). The autonomous driving control method may also include determining whether to reduce the main braking pressure based on the calculated brake temperature (S1120). The autonomous driving control method may also include calculating the decreased amount of the main braking pressure and the increased amount of the speed of the autonomous vehicle based on the decreased amount of the main braking pressure in the travel-intended-route when it is determined to reduce the main braking pressure (S1130). The autonomous driving control method may also include limiting the maximum speed of the autonomous vehicle before the autonomous vehicle enters the travel-intended-route based on the increased amount of the speed (S1140).

The calculating of the travel resistance, the main braking pressure, and the brake temperature in the travel-intended-route of the autonomous vehicle including the downhill route (S1110) may be performed by the calculation devices 210 and 310.

As an example, the calculating of the travel resistance, the main braking pressure, and the brake temperature in the travel-intended-route of the autonomous vehicle including the downhill route (S1110) may include calculating, by the calculation device, the travel resistance based on the air resistance, the rolling resistance, and the gradient resistance.

As an example, the calculating of the travel resistance, the main braking pressure, and the brake temperature in the travel-intended-route of the autonomous vehicle including the downhill route (S1110) may include calculating, by the calculating device, the main braking pressure based on the main braking force calculated based on the travel resistance and the auxiliary brake braking force.

As an example, the calculating of the travel resistance, the main braking pressure, and the brake temperature in the travel-intended-route of the autonomous vehicle including the downhill route (S1110) may include calculating, by the calculating device, the main braking pressure based on the main braking force based on the mapping table for the correlation between the preset braking force and the main braking pressure.

As an example, the calculating of the travel resistance, the main braking pressure, and the brake temperature in the travel-intended-route of the autonomous vehicle including the downhill route (S1110) may include calculating, by the calculating device, the brake temperature based on the main braking pressure over time calculated through the gradient of the travel-intended-route.

As an example, the calculating of the travel resistance, the main braking pressure, and the brake temperature in the travel-intended-route of the autonomous vehicle including the downhill route (S1110) may include calculating, by the calculating device, the brake temperature based on the temperature increase characteristic of the brake disc when the main braking pressure is applied and based on the temperature decrease characteristic of the brake disc when the main braking pressure is not applied.

The determining of whether to reduce the main braking pressure based on the calculated brake temperature (S1120) may be performed by the controllers 220 and 320.

As an example, the determining of whether to reduce the main braking pressure based on the calculated brake temperature

(S1120) may include determining, by the controller, to decrease the main braking pressure when the calculated brake temperature exceeds the preset reference temperature at which the braking force of the brake is reduced by the deterioration.

The calculating of the decreased amount of the main braking pressure and the increased amount of the speed of the autonomous vehicle based on the decreased amount of the main braking pressure in the travel-intended-route when it is determined to reduce the main braking pressure (S1130) may be performed by the controllers 220 and 320.

As an example, the calculating of the decreased amount of the main braking pressure and the increased amount of the speed of the autonomous vehicle based on the decreased amount of the main braking pressure in the travel-intended-route when it is determined to reduce the main braking pressure (S1130) may include calculating, by the controller, the increased amount of the speed of the autonomous vehicle based on the decreased amount of the main braking pressure calculated such that the brake temperature does not exceed the preset reference temperature at which the braking force of the brake is reduced by the deterioration.

The limiting of the maximum speed of the autonomous vehicle before the autonomous vehicle enters the travel-intended-route based on the increased amount of the speed (S1140) may be performed by the controllers 220 and 320.

As an example, the limiting of the maximum speed of the autonomous vehicle before the autonomous vehicle enters the travel-intended-route based on the increased amount of the speed (S1140) may include limiting, by the controller, the maximum speed of the autonomous vehicle based on the increased amount of the speed before the autonomous vehicle enters the travel-intended-route such that the speed of the autonomous vehicle at the end point of the travel-intended-route is the same as the speed of the autonomous vehicle at the end point of the travel-intended-route in the case in which the main braking pressure is not reduced.

As an example, the autonomous driving control method may further include storing as the mapping data, by the calculation device, the braking force and the main braking pressure measured during the braking of the autonomous vehicle while the autonomous vehicle is traveling.

The operations of the method or the algorithm described in connection with the embodiments disclosed herein may be embodied directly in hardware or a software module executed by the processor or in a combination thereof. The software module may reside on a storage medium (i.e., the memory and/or the storage) such as a RAM, a flash memory, a ROM, an EPROM, an EEPROM, a register, a hard disk, a removable disk, and a CD-ROM.

The storage medium is coupled to the processor, which may read information from and write information to the storage medium. In another method, the storage medium may be integral with the processor. The processor and the storage medium may reside within an application specific integrated circuit (ASIC). The ASIC may reside within the user terminal. In another method, the processor and the storage medium may reside as individual components in the user terminal.

The description above merely illustrates the technical idea of the present disclosure, and various modifications and changes may be made by those having ordinary skill in the art without departing from the characteristics of the present disclosure.

Therefore, the embodiments disclosed in the present disclosure are not intended to limit the technical idea of the present disclosure but to illustrate the present disclosure. Thus, the scope of the technical idea of the present disclosure is not limited by the embodiments. The scope of the present disclosure should be construed as being covered by the scope of the appended claims. All technical ideas falling within the scope of the claims should be construed as being included in the scope of the present disclosure.

Effects of the device and the method for controlling the autonomous driving according to the present disclosure are as follows.

According to at least one of the embodiments of the present disclosure, the device and the method for controlling the autonomous driving that control the speed of the autonomous vehicle before the downhill travel may be provided.

In addition, according to at least one of the embodiments of the present disclosure, the device and the method for controlling the autonomous driving may be provided to prevent the decrease in the braking force of the brake even in the harsh driving pattern of the fully autonomous vehicle without the driver by controlling the speed of the autonomous vehicle before the downhill travel.

In addition, according to at least one of the embodiments of the present disclosure, the device and the method for controlling the autonomous driving may be provided to prevent the deterioration of the brake in the downhill gradient travel situation of the autonomous vehicle.

In addition, according to at least one of the embodiments of the present disclosure, the device and the method for controlling the autonomous driving may be provided to prolong the life of the brake of the autonomous vehicle by limiting the speed of the autonomous vehicle to reduce the fatigue of the brake.

In addition, according to at least one of the embodiments of the present disclosure, the device and the method for controlling the autonomous driving may be provided to control the autonomous driving such that the autonomous driving may be performed at the target speed by adjusting the speed of the autonomous vehicle after traveling the downhill gradient to the target speed.

In addition, various effects directly or indirectly identified through this document may be provided.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A device for controlling autonomous driving, the device comprising:
a calculation device configured to calculate a travel resistance of an autonomous vehicle on a travel-intended-route, including a downhill route, a main braking pressure required to travel at a constant speed, and a brake temperature based on braking; and
a controller configured to
determine whether to reduce the main braking pressure based on the calculated brake temperature,
calculate a decreased amount of the main braking pressure and an increased amount of a speed of the autonomous vehicle based on the decreased amount of the main braking pressure on the travel-intended-route when determining to reduce the main braking pressure, and
limit a maximum speed of the autonomous vehicle before the autonomous vehicle enters the travel-intended-route based on the increased amount of the speed.

2. The device of claim 1, wherein the calculation device is configured to calculate the travel resistance based on an air resistance, a rolling resistance, and a gradient resistance.

3. The device of claim 1, wherein the calculation device is configured to calculate the main braking pressure based on a main braking force calculated based on the travel resistance and an auxiliary brake braking force.

4. The device of claim 3, wherein the calculation device is configured to calculate the main braking pressure based on the main braking force based on a mapping table for a correlation between a preset braking force and the main braking pressure.

5. The device of claim 1, wherein the calculation device is configured to store a braking force and the main braking pressure measured during braking of the autonomous vehicle while traveling as mapping data.

6. The device of claim 1, wherein the calculation device is configured to calculate the brake temperature based on the main braking pressure over time calculated through a gradient of the travel-intended-route.

7. The device of claim 1, wherein the calculation device is configured to calculate the brake temperature based on a temperature increase characteristic of a brake disc when the main braking pressure is applied and based on a temperature decrease characteristic of the brake disc when the main braking pressure is not applied.

8. The device of claim 1, wherein the controller is configured to determine to reduce the main braking pressure when the calculated brake temperature exceeds a preset reference temperature where a braking force of a brake is reduced by deterioration.

9. The device of claim 1, wherein the controller is configured to calculate the increased amount of the speed of the autonomous vehicle based on the decreased amount of the main braking pressure calculated such that the brake temperature does not exceed a preset reference temperature where a braking force of a brake is reduced by deterioration.

10. The device of claim 1, wherein the controller is configured to limit the maximum speed of the autonomous vehicle before the autonomous vehicle enters the travel-intended-route based on the speed increased amount such that a speed of the autonomous vehicle at an end point of the travel-intended-route is the same as a speed of the autonomous vehicle at the end point of the travel-intended-route when the main braking pressure is not reduced.

11. A method for controlling autonomous driving, the method comprising:
calculating, by a calculation device, a travel resistance of an autonomous vehicle on a travel-intended-route, including a downhill route, a main braking pressure required to travel at a constant speed, and a brake temperature based on braking;
determining, by a controller, whether to reduce the main braking pressure based on the calculated brake temperature;
calculating, by the controller, a decreased amount of the main braking pressure and an increased amount of a speed of the autonomous vehicle based on the decreased amount of the main braking pressure on the travel-intended-route when determining to reduce the main braking pressure; and
limiting, by the controller, a maximum speed of the autonomous vehicle before the autonomous vehicle enters the travel-intended-route based on the increased amount of the speed.

12. The method of claim 11, wherein the calculating, by the calculation device, of the travel resistance of the autonomous vehicle on the travel-intended-route, including the downhill route, the main braking pressure required to travel at the constant speed, and the brake temperature based on the braking includes:
calculating, by the calculation device, the travel resistance based on an air resistance, a rolling resistance, and a gradient resistance.

13. The method of claim 11, wherein the calculating, by the calculation device, of the travel resistance of the autonomous vehicle on the travel-intended-route, including the downhill route, the main braking pressure required to travel at the constant speed, and the brake temperature based on the braking includes:
calculating, by the calculation device, the main braking pressure based on a main braking force calculated based on the travel resistance and an auxiliary brake braking force.

14. The method of claim 13, wherein the calculating, by the calculation device, of the travel resistance of the autonomous vehicle on the travel-intended-route, including the downhill route, the main braking pressure required to travel at the constant speed, and the brake temperature based on the braking includes:
calculating, by the calculation device, the main braking pressure based on the main braking force based on a mapping table for a correlation between a preset braking force and the main braking pressure.

15. The method of claim 11, further comprising:
storing, by the calculation device, a braking force and the main braking pressure measured during braking of the autonomous vehicle while traveling as mapping data.

16. The method of claim 11, wherein the calculating, by the calculation device, of the travel resistance of the autonomous vehicle on the travel-intended-route, including the downhill route, the main braking pressure required to travel at the constant speed, and the brake temperature based on the braking includes:
calculating, by the calculation device, the brake temperature based on the main braking pressure over time calculated through a gradient of the travel-intended-route.

17. The method of claim 11, wherein the calculating, by the calculation device, of the travel resistance of the autonomous vehicle on the travel-intended-route, including the downhill route, the main braking pressure required to travel at the constant speed, and the brake temperature based on the braking includes:
calculating, by the calculation device, the brake temperature based on a temperature increase characteristic of a brake disc when the main braking pressure is applied and based on a temperature decrease characteristic of the brake disc when the main braking pressure is not applied.

18. The method of claim 11, wherein the determining, by the controller, of whether to reduce the main braking pressure based on the calculated brake temperature includes:
determining, by the controller, to reduce the main braking pressure when the calculated brake temperature exceeds a preset reference temperature where a braking force of a brake is reduced by deterioration.

19. The method of claim 11, wherein the calculating, by the controller, of the decreased amount of the main braking pressure and the increased amount of the speed of the autonomous vehicle based on the decreased amount of the main braking pressure on the travel-intended-route when determining to reduce the main braking pressure includes:
calculating, by the controller, the increased amount of the speed of the autonomous vehicle based on the decreased amount of the main braking pressure calculated such that the brake temperature does not exceed a preset reference temperature where a braking force of a brake is reduced by deterioration.

20. The method of claim 11, wherein the limiting, by the controller, of the maximum speed of the autonomous vehicle before the autonomous vehicle enters the travel-intended-route based on the increased amount of the speed includes:
limiting, by the controller, the maximum speed of the autonomous vehicle before the autonomous vehicle enters the travel-intended-route based on the speed increased amount such that a speed of the autonomous vehicle at an end point of the travel-intended-route is the same as a speed of the autonomous vehicle at the end point of the travel-intended-route when the main braking pressure is not reduced.
